(19) United States
(12) Patent Application Publication
(10) Pub. No.: US 2007/0036036 A1
(43) Pub. Date: Feb. 15, 2007

(54) Pill timer

(76) Inventors: Charles Kadish, Crystal Lake, IL (US); Richard Binder, Highland Park, IL (US); Nicholas S. Chibucos, Bloomingdale, IL (US)

Correspondence Address: GREER, BURNS & CRAIN, 300 S WACKER DR, 25TH FLOOR, CHICAGO, IL, 60606, US

(21) Appl. No.: 11/361,762

(22) Filed: Feb. 24, 2006

Related U.S. Application Data
(60) Provisional application No. 60/655,847, filed on Feb. 24, 2005.

(51) Int. Cl. G04B 19/06

(52) U.S. Cl. 368/230

(57) ABSTRACT

A portable programmable timer for notifying a user of an appointment, such as a scheduled time to take medication or a supplement, includes a display, a speaker capable of providing audible alerts, a processor to control the operations of said device; a program comprising routines and parameters that control said promotion device stored in the processor, a programming interface for entering reminder data into the device, nonvolatile memory for storing the reminder data, and an input/output interface for updating the program or transferring alert data into the device.

This application is a continuation of U.S. Provisional Application 60/655,847 filed Feb. 24, 2005.

### BACKGROUND OF THE INVENTION

The present invention relates generally to a portable programmable timer designed to notify a user when to take a medication or supplement.

With the advancement of medical science, new drugs have been discovered to treat chronic ailments. Failure to take a medication according to the prescribed schedule can greatly affect the efficacy of the medication.

Similarly, many Americans have discovered the benefits of taking nutritional supplements and vitamins. However, the efficacy of these supplements is greatly affected by when they are taken (before meals, with meals, after meals, in the morning, at night, etc.) If a supplement is taken at the wrong time, its effectiveness is greatly diminished.

It is not uncommon for the person taking the vitamin or supplement to forget to take the vitamin or supplement at the correct time, especially if the user is taking multiple prescriptions or vitamins. As a result, there is a need for an inexpensive device to assist an individual primarily in scheduling the intake of medications and/or supplements.

Further, this device must be operable and usable by a person who may have limited manual dexterity or poor vision and/or poor hearing, as is the case with older Americans who are most in need of such a device.

### BRIEF SUMMARY OF THE INVENTION

The above-listed objects are met or exceeded by the portable timer of the instant invention, that provides a small, microprocessor-based, battery-powered, and portable device capable of being carried on a person (shirt-pocket, etc.). The device assists an individual primarily in scheduling the intake of medications and/or supplements. Additionally, the portable timer would allow the tracking of other non-medication appointments which the user wishes to schedule. The portable timer is programmable to alert the user at the appropriate time and remind the user of the appropriate medication/supplement, or other appointment, due at that time.

Alerts can be single-occurrence events or repeating events. Further, alerts can be programmed so that one alert occurs in conjunction with a second alert. For example, if one medication must be taken before a second medication, the portable timer can be programmed so that the alert notifying the user to take the first medication occurs before the alert notifying the user to take the second medication. The alerts for the two medications can be interdependent, assuring that the alert for the second medication occurs within the prescribed time frame. In this regard, it is desirable that the portable timer supports “infinitely variable” programming of the alert times, periodic repetition of the alert, as well as a capability of staggering of the alert schedule in accordance with a prescribed regimen.

The portable timer is envisioned to be used by a wide variety of individuals, and accordingly, its operation should be flexible, easy to understand, and intuitive. The design strives to accommodate those with limited perception (vision and/or hearing) capabilities.

The alarm has a display, preferably a LCD graphic display with capability for large type characters. In a preferred embodiment, this display is illuminated with a backlight. In addition to the previously-described display, the device also has a voice output.

The device also should come preprogrammed with popular medication schedules for ease of programming. Alternatively, the device should have an interface, such as an I/O connection, such as a USB port, to enable it to be connected to another computing device so that a medical professional can download prescription information directly to the portable timer.

When an alert is programmed into the portable timer, it is stored in nonvolatile memory, preferably flash memory. This way, if the batteries fail or malfunctions, the user's prescription schedule is not lost.

The device also has a second memory, containing a program that operates the portable timer. This program causes a series of menus to be displayed on the screen from which a user can select the timing of an alert, the frequency of an alert, the type of alert (voice, vibrating or audible), whether the alert is to be related to a previously programmed alert, and what medication or supplement is to be taken. Preferably, the names of popular medications will be preprogrammed into the device.

The alerts can take the form of audible alert, such as a buzzing or ringing noise, a voice alert, or a silent vibrating alert. These alerts can be programmed to repeat themselves at regular intervals if the user does not acknowledge that he has taken the medication corresponding to the alert.

### BRIEF DESCRIPTION OF THE DRAWINGS

FIG. 1 shows a front view of an embodiment of the portable timer of the invention.

FIG. 2 shows a rear view of an embodiment of the portable timer of the invention

FIG. 3 shows a block diagram of an embodiment of the portable timer of the invention.

FIG. 4 is a flowchart showing the general operation of the program that controls the portable timer of the invention.

FIG. 5 is a flowchart showing the steps to program the portable timer of the invention with a new schedule or appointment.

FIG. 6 is a view of a display showing the setting of the date and/or time in the portable timer of the invention

FIG. 7 is a view of a display showing the programming of an appointment into the device.

FIG. 8 is a view of a display showing programming of an appointment through the selection of a preprogrammed medication schedule.

FIG. 9 a view of a display showing an appointment that has been programmed in the timer.

FIG. 10 is a view of a display showing the settings of the programmable timer.

FIG. 11 a view of a display showing an alarm that has previously been entered into the programmable timer at the time associated with the appointment.

FIG. 12 is a display of a screenshot of software on a computer that can be used directly input data into the computer via the I/O interface.

FIG. 13 shows the relationship between schedules and appointments in the program controlling the timer.

FIG. 14 shows an example of interdependent appointments in the program controlling the timer.

FIG. 15 is a flowchart showing the operation of the timer of the invention.

### DEFINITIONS

This section defines some terms found in the document which may be unfamiliar to the reader.
A/D, ADC Analog to Digital Converter
CAD Computer-Aided Design
CRC Cyclic Redundancy Check (CRC is a method of data error detection)
IrDA Infra-red Data Association
LCD Liquid Crystal Display
LED Light Emitting Diode
Mb Mega bits (1 Mb=1048576 bits)
PCB Printed Circuit Board
PWM Pulse-Width Modulation
USART Universal Synchronous/Asynchronous Receiver-Transmitter
RAM Random-Access Memory

Schedule—A Schedule is a single item to be tracked by Timer, e.g., a medication, a future engagement, or any other issue for which the user wants to arrange a reminder alarm. The timer is capable of storing and tracking a number (currently 22) of these schedules. Each Schedule may be thought of as a ‘container’ for individual appointments, described below.

Appointment—An Appointment is a planned occurrence of an alarm. Each schedule (described above) can contain one or more appointments (currently up to 12 appointments per schedule). Appointments may be of a few varieties, depending on the intended frequency of the alarm, or intended dependency on another alarm. The varieties of appointments is described below.

Time—“Time” in the portable timer system refers to a specific day, hour, and minute; or an interval of days, hours, and minutes.

The One-Time Appointment sets one alarm to occur at one specific time (day, hour, and minute).

The Periodic Appointment sets an alarm to occur at a specific time, and thereafter at specific, evenly spaced intervals.

The Pre-Dependent Appointment sets an alarm to occur at a specific interval before another specified appointment, contained in another schedule. The referenced appointment must be of One-Time or Periodic type; circular references are not allowed.

The Post-Dependent Appointment likewise sets an alarm to occur at a specific interval after another specified appointment, contained in another schedule. Again, the referenced appointment must be of One-Time or Periodic type; circular references are not allowed.

### DETAILED DESCRIPTION OF THE INVENTION

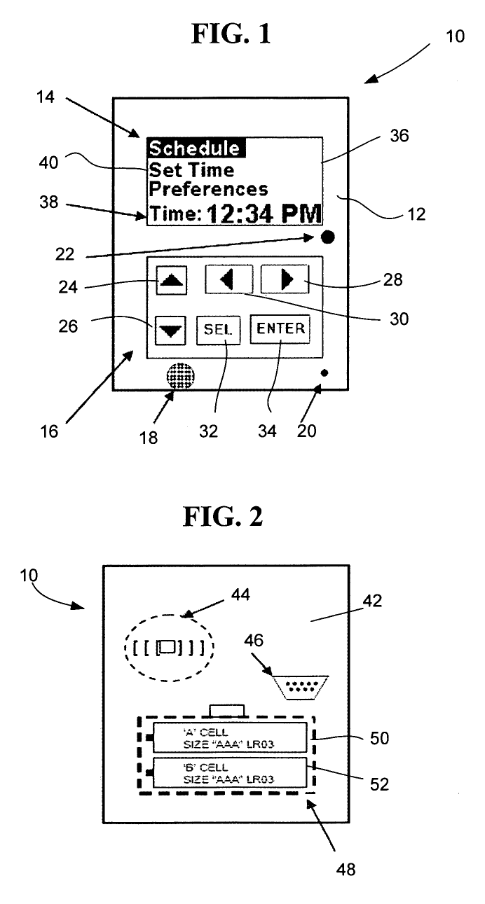

Referring to FIG. 1, a front view 12 of the current portable timer 10. Portable timer has a display and a keypad. A six-key keypad provides the user the means to navigate and control the Timer. The SEL, or Select key, is used to toggle through various menu options. The Up/Down keys on the left of the keypad are used to increment (Up) or decrement (Down) adjustable parameters, such as a time display. Alternately, the Up/Down keys serve in the vertically-scrolling menus, such as scrolling through appointments, names in the pick list (described later), or other user choices in certain menus. The Left/Right keys in the upper right of the keypad are used in horizontally-scrolling menus, such as scrolling through schedules, or the Schedule name entry menu (described later). The user presses the Enter key to confirm choice of the currently highlighted menu selection, or acknowledgment of other menu information. The Timer keys feature hold-and-auto-repeat operation, whereby depressing and holding a key causes rapid repetition of the particular key as if it were pressed many times in succession by the user. (Auto-repeat is disabled in the context of certain menus where the effect is not required.)

Display 13 is preferably an LCD display module, such as the TM12864NCIG module from Tianma Microelectronics Co. Use of a graphic display module permits display of oversize type characters, for example, 12 W×18 H (˜5 mm×8 mm) characters in a 3 line by 10 character display, or 10 W×15 H (˜4 mm×6 mm) characters in a 4 line by 12 character display. In contrast, typical character displays offer 5 H×8 W (3 mm×5 mm) characters in 2-line by 16-character display. Additionally, the graphic display offers the advantage of representing some of the user information pictorially instead of text-only. This display incorporates the LCD controller and display bitmap RAM internally, with a simple serial interface to the microcontroller. Since the LCD controller is a bitmap device, character/graphic generation is done by the microcontroller and uploaded as bitmap information to the display controller. An external backlight is provided, under control of the microcontroller software, to provide display illumination.

The Timer stores digital audio data in a dedicated flash memory device. The pre-recorded audio clips are designed to prompt the user through the various menus, to simplify navigation of the menus and programming of the schedules. An objective of the audio prompts is to allow operation of the device by a person with limited visual perception. The following are examples of items that can be announced by the Timer voice prompt system.
Times: Weekday, Month, Day, Year, Hour (AM or PM), Minute.
Intervals can be announced as Minutes, Hours, Days, Months, Years. Ordinal suffixes (st, nd, rd, th,) are added automatically, as required.
Titles of icons for all menus. The titles are announced whenever the user highlights the appropriate icon on the display. Examples are: Schedule, Set Time, Preferences, Yes, No, Exit, Edit, Enable, Next, Done, Save, Cancel, Pick, Playback, Redo.
Supplemental prompts and instructions for navigating menus (e.g., use up/down/enter), announced in context of the various menus.

The Timer shall store preprogrammed audio clips to prompt the user through the menus. The Timer can also store use recorded audio clips to accompany certain timer settings. Voice prompts for menus are on by default, but may be optionally turned off by the user.

In addition, the Timer provides a built-in microphone for digitally recording up to 5 seconds of user audio, to be stored with each schedule. This allows each schedule title to be accompanied with an audio cue when browsing through schedules, or for audio identification at alarm time. User digital audio is stored in a portion of the same 32-MBit flash memory used for the pre-recorded voice prompts.

The timer uses a high brightness blinking LED to alert the user to an alarm. A high brightness, red LED is mounted on the Timer front panel, to alert the user visually of an alarm condition. The LED is programmed to flash at about 4 flashes per second, for a duration of approximately 5 to 10 seconds, whenever an alarm time is reached. As mentioned previously, this LED flashing occurs every 60 seconds, for as long as any elapsed alarm information remains in the history buffer, unacknowledged by the user. No provision is made for disabling the LED, save the condition that all schedules and appointments are disabled by the user, or the user has no appointments scheduled at all.

In addition to the vibratory and audible alarm, the microcontroller controls a separate alarm LED is mounted on the device case. This LED is a high-intensity type, visible red in color, which is flashed by the microcontroller for maximum attention.

A motorized vibrating mechanism is provided internal to the Timer, to optionally alert tne user of an alarm occurrence via the sense of touch. The vibrating mechanism is activated continuously for 5 to 10 seconds, concurrent with the LED. This device is a motorized, rotating eccentric-mass type of mechanism. he internal vibration provides an optional way to signal an alarm to the user, rather than audio tones. This is similar to devices such as mobile phones and pagers. The vibrating mechanism can be optionally enabled or disabled by the user, with one exception, described next.

The Timer incorporates a feature for the user to mute the audio alarm when desired. An option exists allowing the user to turn the audio alarm tone off, however, turning the alarm tone off automatically enables the vibrating alarm mechanism. In addition, the Alarm LED (described above) remains enabled regardless of the audio time and vibrator options. In this way, the possibility of the user overlooking an alarm is reduced.

The LCD display in the Timer is fitted with green LEDs at either edge, which allow the display to be illuminated.

The Timer accepts two standard batteries which may be AAA-sized alkaline, rechargeable alkaline, Ni—Cd, or NiMH batteries (cells) for power, labeled cell A and cell B. On initial start-up, the operating software waits until both cells are inserted before commencing operation. The operating power for the Timer is drawn from one cell only; the other cell is essentially disconnected, and serves as a standby cell. The voltage on the operating cell is sampled every two minutes, approximately. When the voltage on the operating cell falls below a threshold, indicating the near exhaustion of the cell, the microcontroller software switches the All-Timer's special power circuitry to operate off of the standby cell, and disconnects the spent cell. At this time, a notification to the user to change the spent cell (A or B), is issued to the History buffer, and an alarm is sounded. Until the user changes the spent cell (described next), a warning to change the cell will be issued twice per day to the History buffer.

To change cells, the user replaces the spent cell indicated (A or B), and initiates a New Battery utility routine. This routine attempts to load the newly changed cell, to test its capacity to a degree (i.e., the new cell is actually installed, and it is not completely dead). If the newly replaced cell appears sufficient, it is designated as the new standby cell and placed in the disconnected state, and the periodic warning messages are terminated. The cycle continues from this point, exchanging the standby for the operating cell whenever the operating cell runs low.

With this battery switching arrangement, power to the Timer need not be interrupted, so timekeeping and other settings are not disturbed. Also, the active/standby cell arrangement reduces the possibility of the user overlooking alarms due to loss of power to the Timer. Of course, the user must be diligent in installing a fresh cell in a timely manner, in the proper location, and executing the New Battery utility. Should the user mistakenly remove the operating cell, or run both cells until they are depleted, timekeeping and other settings will need to be reset when the cells are restored.

The Timer is also preferably equipped with a RS-232-level serial interface, accessible by a cable connection to the microcontroller circuit board, internal to the Timer case. The interface operates at 115.2 Kbaud, 8 bits, no parity, hardware flow control. Via the RS-232 interface, the microcontroller presents a debugging console for software development and data transfer. The console can be accessed with a terminal program running on a PC, or another utility program, which is described later.

A further application envisioned for the Timer serial port would be to interface to a modem, for the user to receive remote data transfers from a central computer system, or customer support center, by plugging into a standard analog phone jack. This mode of operation offers the advantage of requiring no PC to accomplish programming, and would require essentially no user intervention.

Timer settings created by the user are stored in nonvolatile memory (Flash, EEPROM, etc.) Audio recordings created by the user are also stored in nonvolatile memory. The use of nonvolatile memory ensures that user settings are preserved if both batteries are interrupted. Variables used by the timer in operation (current timeofday, etc.) are stored in volatile RAM. RAM contents are lost if both batteries are interrupted.

Application Specific Integrated Circuit (ASIC) Functions: Microcontroller, Microcontroller program ROM, LCD driver, PC USB/Serial Interface Audio D/A Converter & Speaker Driver, * Microphone Amplifier and A/D Converter, Display LED, Vibrator Motor Drivers, Keypad Interface, Preprogrammed Audio Voice Prompts (ROM), Nonvolatile Memory for Timer Settings & Userrecorded Audio

Displays User-entered Text Displays numerics for Time, Date, etc. Highlight Icon desirable to prompt User Input. Icons may be implemented for common functions (Next/Done/Exit, etc.) Case Design, CreditCard size is desirable (55 mm ×85 mm, approximately). Foldover keypad design is desirable to prevent inadvertent user keystrokes. When folded, the LCD display should still be visible to the user.

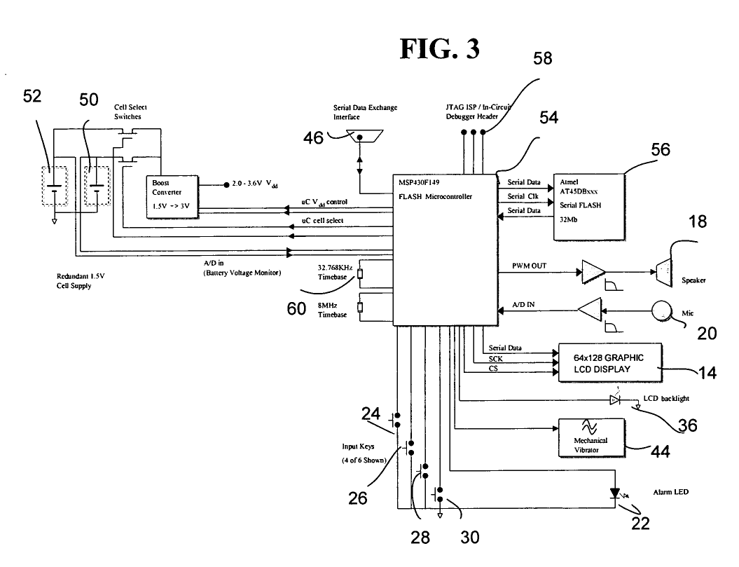

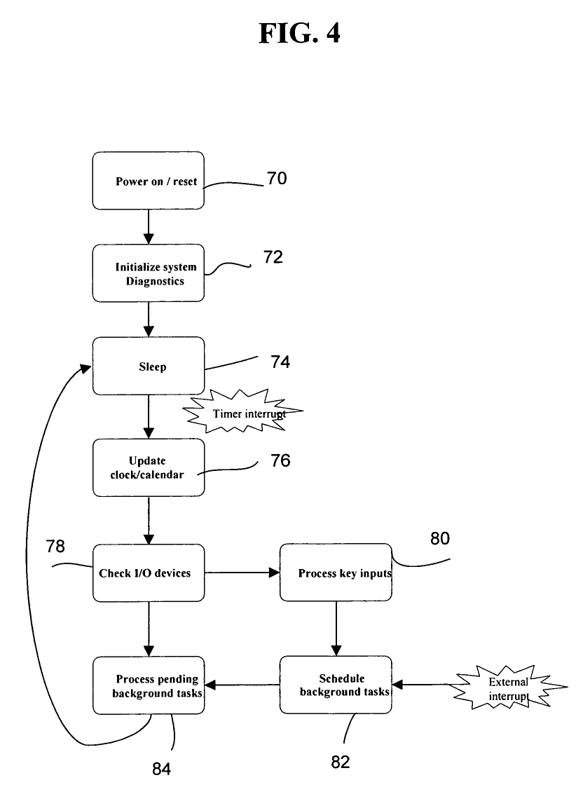

FIG. 3 generally shows a block diagram of the device of the invention. The device is controlled by a main processor 30, which contains a program with the operations and feed parameters controlling the device. This device also has sa peakers to generate audible alarms, either in the form of bells or a voice alert. Alternatively, such alerts could come in the form of a vibration of the device generated by the mechanical vibrator 34. In addition, an LED on the device 36 can light up as well. In order to input voice alerts into the device a microphone 38 is provided. Such voice alerts are stored in flash memory 40. Alternatively, instead of using input keys 16-28 on keypad 14 to input prescription information, this information can be inputted via serial data interchange 42. This can take the form of any IO device, but is preferably some form of standard connector such as a USB interface. This data once entered is stored in flash memory 30. The device is powered by an operational battery 44 and a redundant battery 46. Further, in order to ensure that the display is visible in poor lighting conditions, the display may optionally be provided with a LCD backlight 48.

The central microcontroller is an integrated, flash memory-based, 16-bit RISC microcontroller. This microcontroller family is designed for low-power, battery operated and hand-held type applications with many features to limit power consumption and maximize battery life. This may be a member of the Texas Instruments MSP430x14x family. The MSP430F149 used in one embodiment of the Timer features 60K bytes of program flash memory, and 2K bytes of on-chip SRAM. Additional features include multiple on-board timers with capture/compare hardware, a hardware multiplier, a multi-channel A/D converter, programmable USARTs, and a dual clock input scheme. A unique feature of the MSP430x family is the JTAG In-Circuit Serial Programming/In-Circuit Emulation, hardware features built on-chip to allow rapid programming and debug of operational code without removing the device from the system.

Interfaced to the MSP430F149 microcontroller is an Atmel AT45DB32 serial flash device reserved solely for storage of voice playback data. The AT45DB32 serial flash features a blocked architecture, allowing erasure and reprogramming in small segments without the need to erase the entire device. Three levels of granularity provide erasure/reprogram in approximately 128K, 4K, or 528 byte quantities.

A single micro-speaker provides the sounding device for alarms, voice playback, and other audible cues. The speaker is driven from the microcontroller PWM output, with some analog low-pass filtering and amplification provided. A separate miniature electret microphone serves as a pickup for voice recording, with analog filtering and signal amplification before sampling by the microcontroller A/D circuitry.

The MSP430F149 features a second on-board U(S)ART which is brought to a connector for an EIA RS-232 type interface port for a personal computer or other terminal/network equipment. Prospectively, an infrared (IrDA-type) interface could be configured for a wireless serial connection, or a modem for remote terminal access.

The battery supply for the Timer is based on a dual, redundant dry-cell arrangement. The cells are standard, readily available 1.5 volt carbon-zinc or alkaline batteries. The design will also accept nickel-cadmium, rechargeable alkaline, or nickel-metal hydride rechargeable cells. One cell supplies active power for all of the Timer circuitry, while the second cell serves as a standby source. In this way, no single cell failure will prevent operation of the device. The microcontroller monitors the analog output voltage of the cells and can elect to switch cells when one becomes weak, and also alerts the user to change the cells. The active cell supplies power to an integrated, high efficiency boost switching regulator to provide a stable operating voltage for the microcontroller and flash memory. The output voltage of the regulator is adjustable, in three discrete steps, by the microcontroller. This allows tailoring of the supply voltage to operating conditions (sleep/active. etc.), in an effort to minimize power consumption.

Low power consumption is achieved by the use of CMOS components and powering down unused circuits during idle periods. The MSP430x14x microcontroller idle shutdown and dual-clock arrangements provide a significant reduction in power consumption. The microcontroller CPU is programmed to shut down during idle code periods, and switches off many internal devices. During idle periods, the microcontroller also disables the CPU clock (up to 8 MHz), reverting to a single 32.768 KHz crystal (used to maintain an internal timer for the time-of-day keeping), to further reduce battery drain. Additionally, the MSP430F149 operates from an internal, programmable clock generator for moderate processing speed and power consumption when maximum data throughput is not required.

Turning now to FIG. 3, shows the operation of the device when in use. The device begins in a power off state 70. When it is initially turned on it goes through a self diagnostic state 72 and the progresses into a sleep state 74. It remains in a sleep state until a timer interrupts 75 occurs, at which point an alarm is sounded. Using an internal clock it updates the calendar 76 and checks for input-output devices 78. If no input-output devices are found, it will process key inputs if such key inputs are detected. Once a key input is inputted it schedules background tasks and then processes these background tasks in step 84. Further if an input-output device is detected it will go straight from step 78 to step 84.

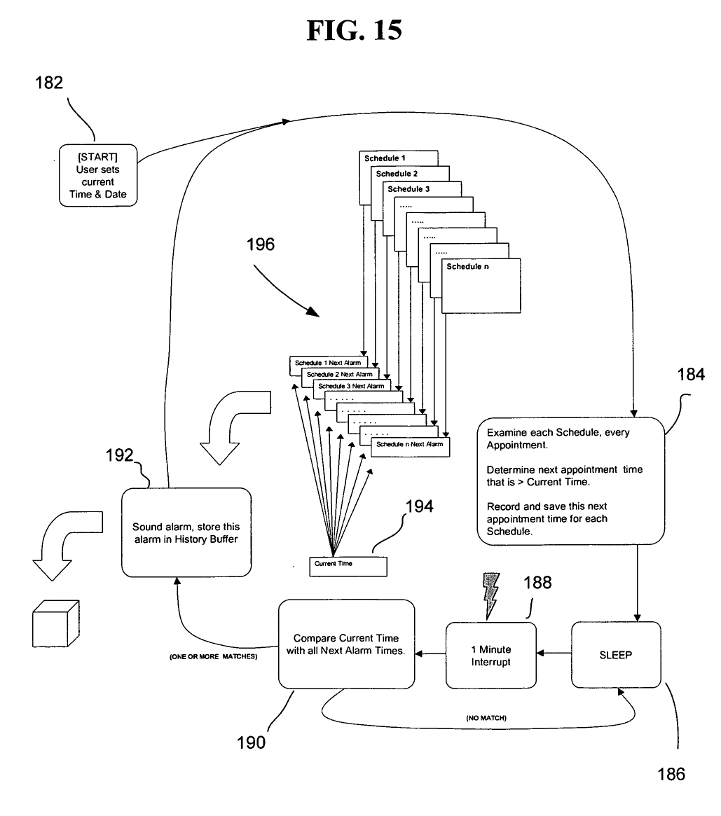

The software architecture of the Timer is based on a simple timer-driven loop to service a clock/calendar routine and process inputs and outputs. FIG. 15 depicts a flow diagram of the Timer operating software.

An operating system is used to provide the features required while facilitating transition to low-cost, high volume manufacturing. The simple operating system also allows optimization to achieve low power consumption, and high real-time efficiency when needed, i.e., voice processing.

After start-up initialization, the microcontroller spends most of the time in the sleep mode. The microcontroller is awakened from the sleep state by a periodic interrupt from an internal time-of-day timer, or another interrupt such as A/D conversion complete, serial interrupt, keypress, etc. The base loop updates the clock/calendar (maintained in software), checks for any inputs, and schedules tasks to respond to the inputs. Any remaining time is used to process scheduled tasks, which are designed as run-to-completion and interruptible. Such tasks are parsing menu information, processing digitized analog data, communications routines, updating the display, etc.

The Timer software may be written in the C language with a special purpose compiler targeted for the MSP430 microcontroller. This approach provides portability at the top levels of the operating software hierarchy. Due to the minimum amount of data memory available on the microcontroller, some subroutines are coded in the native MSP430 assembler to reduce use of stack space and inherent inefficiencies of compiled C. In addition, C library calls are minimized and loaded library routines are kept to a minimum. All arithmetic is performed as integers; neither floating point arithmetic or its runtime code are supported in the Timer software. Short, custom I/O routines have been written to replace larger (albeit more flexible) standard library functions (e.g., printf, scanf, etc.)

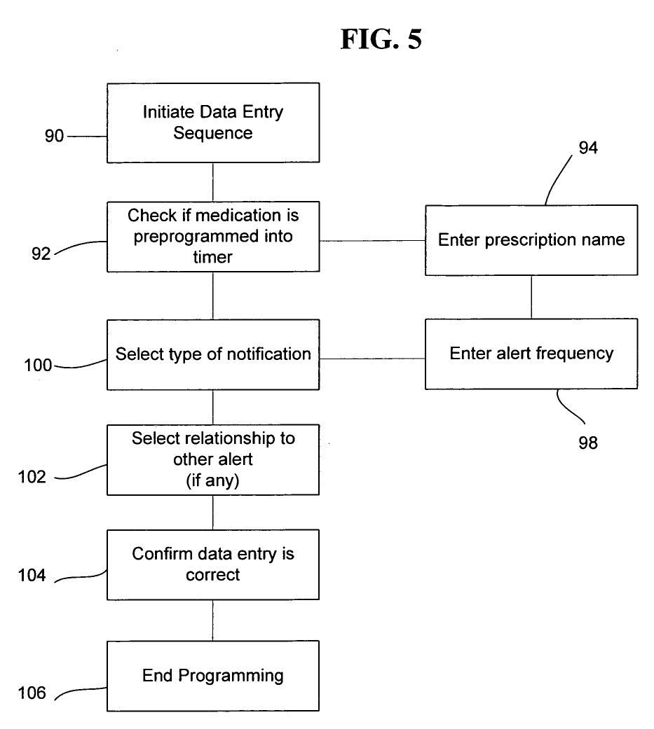

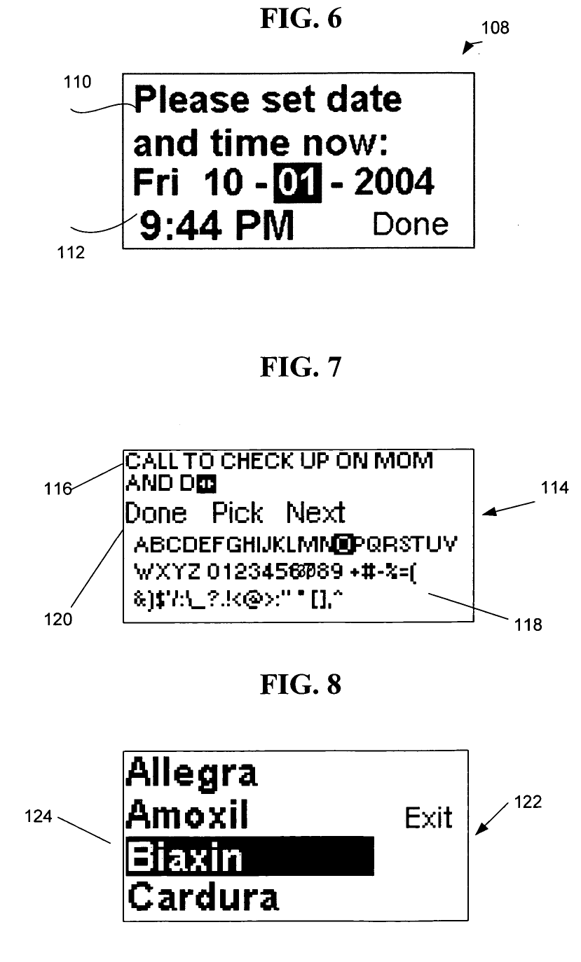

Turning now to FIG. 5 shows a flow chart of the programming step of the invention. Initially, the user selects that they wish to input a new alert. Next the user selects the type of alert at step 90. At step 92 it determines if the is alert relates to a medication or a supplement having preprogrammed parameters in the device if the answer to this question is yes, the medication and dosage amount is selected. If this is consistent with the medication as prescribed by the doctor, this can be selected at step 74 and then proceed to step 100. Otherwise, the user manually enters the prescription or task at step 96 then enters the frequency in step 98. At step 100 it selects the relationship of the administration to any other schedule of medication administration. At this point a user can also enter a voice notification or additional instructions to his or herself if desired. Once this step is recorded the user can then select the sort of alert that they wish, an audible alert, a silent (vibrating) alert, or a voice alert. Once this step is complete the user is asked to confirm his previous instructions at step 106. Once this is completed the program ends at step 108 and the device returns to its sleep status. FIG. 5 shows an example of the general entry step where the user uses the key pad 14 to select text and numbers from a row using the six keys on keypad 14 to navigate amongst the character entry field the directional keys 16, 18 , 20 and 22 are used. Once a desired key is found the select button is pressed and then it is entered. Alternatively, as discussed in step 94, if the medication is already preprogrammed into the system, the user can merely select that medication and the schedule will be automatically created based on the parameters already contained in memory 30. However, it may be desirable for the device to be configured such that medical professionals can input the schedule themselves at the time the medication is prescribed. To do so the medical professional would attach the programmable alarm 10 to a computer at the medical professional's office through input-output connection 42 and download the appropriate schedule into the system in that manner.

The user is allowed to enter custom names for each schedule, of up to approximately 50 characters. If the name is able to fit across a single line of the LCD display (around 15 to 25 characters), the name is displayed in large type characters. Smaller type characters, spanning two LCD lines, are used to display longer Schedule Names.

The user scrolls through the character marquee, located in the lower half of the display, with the Up/Down keys, to select a character. An instance of the elected character is added to the schedule name with each press of the Enter key. Characters are deleted from, or restored to the schedule name with the Left and Right keys, respectively.

The user employs the Up/Down Keys to scroll through the Pick list entries, and Enter to select the appropriate name. The Schedule name is populated with the chosen name, and further edits are possible with the schedule name editor, described above. If the user decides to abort the Pick list with no change, the Select key will toggle the highlight to Exit, and the user presses Enter, returning to the schedule name editor.

FIG. 7 shows the operation of the program which controls the alarm while the device is activated in a waiting state. Once the time and date has been set the alarm determines the upcoming appointment for each schedule currently programmed into the system at step 122. At step 124 the program then reverts to its sleep state. However, at each minute at step 126 it exits its sleep state, compares the current time with the alarm times and looks for a match. If no time is matched it returns to step 124 and sleeps. If an alarm is set for that time, it then goes to step 130 and sounds the alarm associated with that alert in the system. alarms, according to the current time, and the appointments provided by the user. The following figure illustrates the mechanism:

The Timer software program uses a look-ahead algorithm on each appointment in every schedule, to determine the nearest future alarm time for each schedule, relative to the current time. This Next Alarm Time is stored in memory, resulting in an array of times, one storage location for each schedule.

Every 60 seconds, the program is awakened to update the current time-of-day (by one minute), and to scan the Next Alarm time array for any alarm times matching the current time. When a match is found, the alarm is sounded, and the alarm information is stored in a History Buffer (described later) for retrieval by the user. After storing the alarm in the history Buffer, the Next Alarm Time array is updated with new information, and the cycle repeats.

FIG. 8 shows the relationships between a schedule for a particular medication and appointments. A schedule can either have a single oneOtime appointment which occurs at a specific time on a specific date, or an appointment can initially begin at a specific time and thereafter occur at evenly spaced intervals. Alternatively, the alarm can be programmed to have a predependent or postdependent appointment. A predependent appointment occurs at a specific interval before another appointment and a postdependent appointment occurs at a specific interval after a specific appointment. As shown in FIG. 8 the device may be programmed with multiple schedules. In this example a first schedule 1:40, a second schedule 1:42, and a third schedule 1:44 are programmed into the device. The third schedule 1:44 may contain multiple appointments, a first schedule 1:50, a second schedule 1:52, and a third appointment etc.

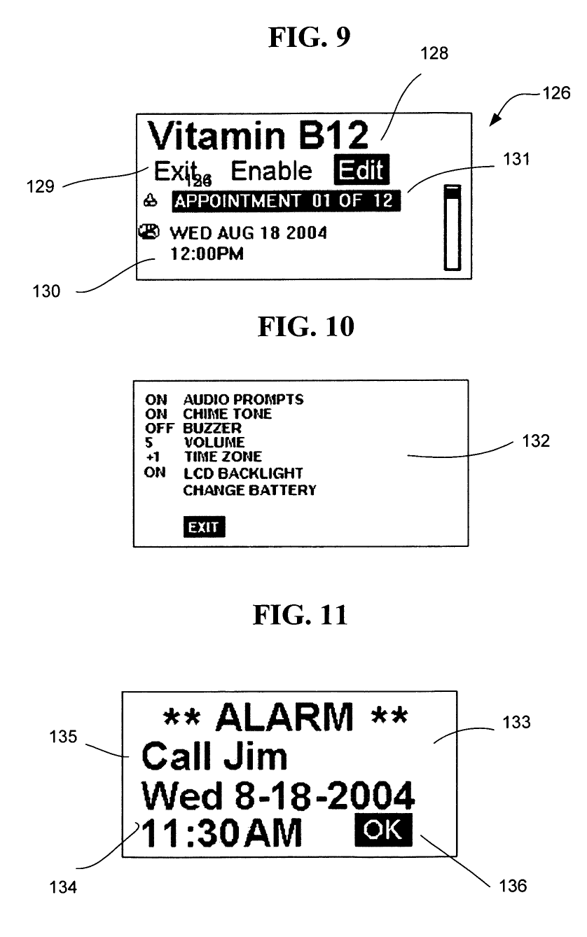

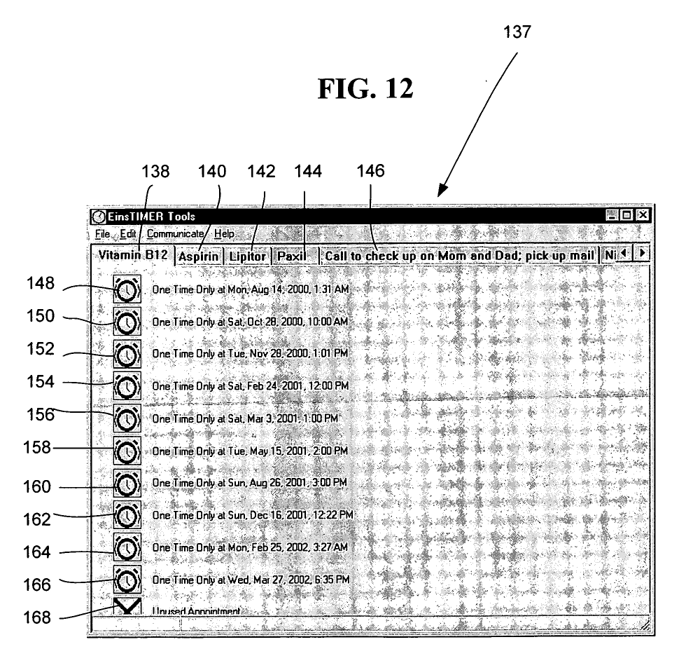

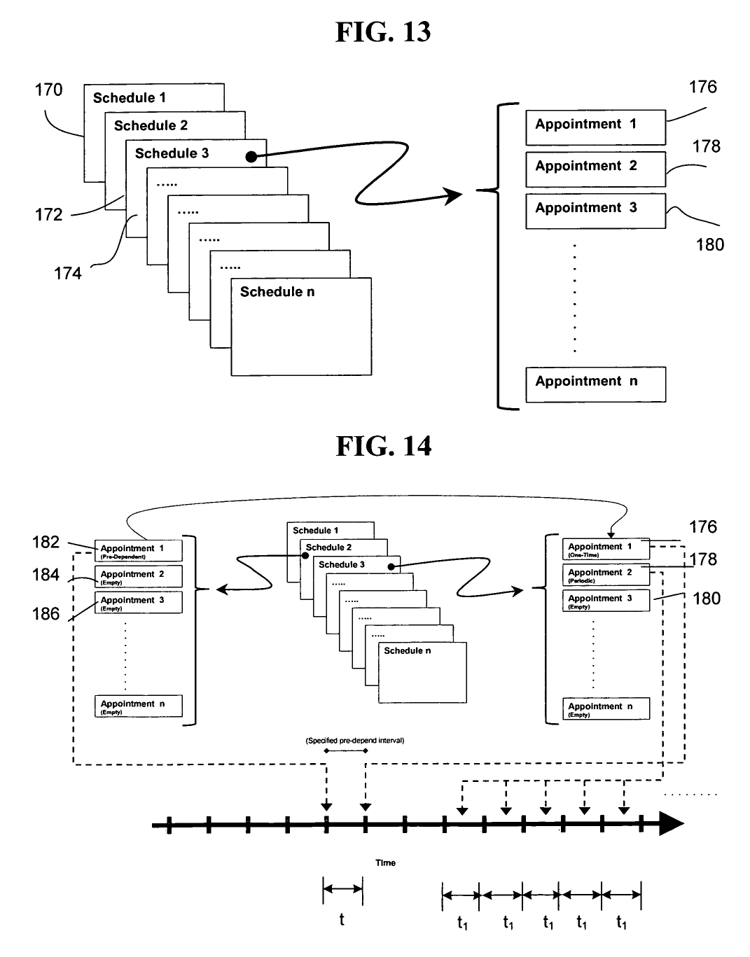

FIG. 9 shows an example where an appointment in the second schedule is related to an appointment in the third schedule. In this case schedule 2 has only one preset appointment, a first appointment 1:48. This appointment is set up as a predependent appointment for the first appointment 1:50 of schedule 3, 1:44. Which then occur at a specific time related to each other. As shown again on the time line, the second appointment 1:52, then occurs at a specific relations ship on a recurrent basis afterwards.

To assist the user in managing alarms as they occur, the Timer features a memory bank of elapsed alarms called the Alarm History buffer. As individual alarms occur, a record of the alarm time, and the Schedule name from which the alarm occurred, are stored in the Alarm History buffer, in chronological order. When one or more elapsed alarms are queued in the History buffer, the History buffer is presented to the user on the display, oldest alarm first. The user must acknowledge each alarm (with a press of the Enter key), and the alarms are successively presented to the user, up through the most recent elapsed alarm. Any audio information associated with the Schedule name, as well as the time of the alarm, is announced as the user recalls each individual entry in the History buffer. As long as any elapsed alarms remain in the History buffer, an alarm tone and LED flash are asserted at one minute intervals to call the user's attention to the elapsed alarms. (The alarm tone may optionally be suppressed by the user via the silent alarm function, described later.)

The Alarm History buffer implemented in the Timer occupies a significant portion of the microcontroller RAM resource; therefore the size of the History buffer is limited to 128 elapsed alarms. The Alarm History buffer is implemented as a circular buffer, so that in the event of exceeding the 128 elapsed alarm limit, the oldest alarms will be successively overwritten by newly elapsed alarms. In this case, the user will be notified of the fact that some elapsed alarms have been lost, before presenting the History data that remains.

The RS-232 debugging console, described above, provides a means to upload or download schedule and appointment data to/from the Timer via a dedicated PC program. This program allows the user to manage schedules, appointments, and utility functions of the timer with the familiar Windows interface. A depiction of the Tool Application is shown below:

The user connects the Timer to a PC with a serial communications cable, and launches the Tool Application on the PC. The tool program allows the user to display, arrange, save, and recall appointments and schedules on the Timer, and/or save and recall appointments and schedules on disk storage of the PC. The Tool Application also allows the user to synchronize the Timer's time-of-day with the current PC time, and to set the various Timer options and preferences.

The Timer features a preference setting to accommodate users traveling across time zones. The Time Zone setting allows the user to select an offset, positive or negative, to be added to the current time-of-day, in one-hour increments. This feature circumvents the need for the user to re-program the current time-of-day setting to adjust to the local time, and likewise allows a simple means to return to the user's ‘home’ time setting. Note that this offset affects only the current time-of-day setting; all appointment times remain as programmed, without any offset added.

The Timer software features some safeguards to detect anomalies in its internal operation. On power up, a self-test is run to test the microcontroller RAM, and check the program memory integrity via cyclic redundancy check (CRC-32). Additionally, separate CRC is computed and stored for schedule memory tables, enable memory, and other critical memory sections. These critical memory sections are checked periodically to detect any unexpected changes in the data, which might impact operation of the Timer. Lastly, throughout the software, a mechanism is built in to detect abnormal or unexpected results of the various software operations.

If an error is detected, the design of the Timer software is to display an on-screen error message (‘system hang’), and an error code, and then halt operation. The error code conveys some information about the internal software condition found, and should be noted. Should this error message occur, the Timer can be re-initialized by depressing the Left and Right arrow keys simultaneously.

Flash memory technology affords the convenience of data retention in the absence of power, and at the same time, the capability to erase and re-write data in-system, as needed. The MSP430F149 microcontroller used in the Timer utilizes internal flash memory for its program storage. The Timer software, in turn, utilizes a portion of this flash memory for storing schedule and appointment data (about 224 bytes per schedule).

Use SRAM (volatile memory technology) to store the schedules. The Timer's un-interrupted battery power arrangement can preserve the RAM data, if the user maintains the batteries properly. Alternatively, a dedicated backup battery scheme could persist the RAM data for an extended time.

1. A portable programmable timer providing reminders to a user, comprising:
a display;
a speaker capable of providing audible alerts;
vibrating means to provide silent alerts;
a processor to control the operations of said device;
a program comprising routines and parameters that control said promotion device stored in said processor;
a programming interface for entering reminder data into the device;
nonvolatile memory for storing said reminder data;
a input/output interface for updating said program or transferring alert data into said device.
